(19) United States
(12) Patent Application Publication
(10) Pub. No.: US 2013/0326630 A1
(43) Pub. Date: Dec. 5, 2013

(54) PRE-PROCESSOR FOR PHYSICAL LAYER SECURITY

(71) Applicant: Whisper Communications, LLC, Atlanta, GA (US)

(72) Inventor: Cenk Argon, Chapel Hill, NC (US)

(21) Appl. No.: 13/908,000

(22) Filed: Jun. 3, 2013

Related U.S. Application Data
(60) Provisional application No. 61/654,338, filed on Jun. 1, 2012.

(51) Int. Cl. G06F 21/60

(52) U.S. Cl. CPC G06F 21/60
USPC 726/26

(57) ABSTRACT

Systems and methods of secure data exchange are disclosed. One such method includes obtaining user data at a physical layer of a transmitter and securing the user data at the physical layer. The user data is secured by processing the user data with a series of non-recursive convolutional encoders interspersed with one or more bit-level permuters. The secured user data is transmitted.

### CROSS REFERENCE TO RELATED APPLICATIONS

This application claims the benefit of U.S. Provisional Application No. 61/654,338, filed Jun. 1, 2012, which is hereby incorporated by reference herein.

### FIELD OF THE DISCLOSURE

The present disclosure relates to data communication, and more specifically, to secure communication at the physical layer.

### BACKGROUND

Conventional methods of providing secure communication over a channel use cryptography. Cryptography relies on the existence of codes that are “hard to break”: that is, one-way functions that are believed to be computationally infeasible to invert. Cryptography has become increasingly more vulnerable to an increase in computing power and to the development of more efficient attacks. Furthermore, the assumptions about the hardness of certain one-way functions have not been proven mathematically, so cryptography is vulnerable if these assumptions are incorrect.

Another weakness of cryptography is the lack of no precise metrics or absolute comparisons between various cryptographic algorithms, showing the tradeoff between reliability and security as a function of the block length of plaintext and ciphertext messages. Instead, a particular cryptographic algorithm is considered “secure” if it survives a defined set of attacks, or “insecure” if it does not.

Cryptography as applied to some media (e.g., wireless networks) also requires a trusted third party as well as complex protocols and system architectures. Therefore, a need exists for these and other problems to be addressed.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure.

FIG. 1 is a block diagram of a communication system that provides physical layer security, according to some embodiments described herein.

FIG. 2 is a block diagram of the secure physical layer from FIG. 1, according to some embodiments described herein.

FIG. 3 is a block diagram of the security transformer of FIG. 2, according to some embodiments described herein.

FIG. 4 is a block diagram of the inverse security transformer of FIG. 2, according to some embodiments described herein.

FIG. 5 is another block diagram of the security transformer of FIG. 2, according to some embodiments described herein.

FIG. 6 is a flow chart illustrating operation of the communication system of FIG. 1, according to embodiments described herein.

FIG. 7 is a hardware block diagram of a device from FIG. 1, according to some embodiments described herein.

### DETAILED DESCRIPTION

Disclosed herein are inventive techniques for securing user data against eavesdropping at the physical layer of a communication system. Security is provided by transforming the data in a manner that produces a bit error rate for an eavesdropper of about one-half. With such a bit error rate, an eavesdropper attempting to recover the user data from intercepted data is as likely to produce an incorrect bit as a correct bit. That is, the transform used by the transmitter has characteristics such that if a 1 is transmitted, the eavesdropper is as likely to recover a 0 as a 1; similarly, the characteristics lead to the eavesdropper being just as likely to (incorrectly) recover a 1 when a 0 is transmitted as to (correctly) recover a 0 when the 0 is transmitted. Given a relatively high bit error rate on the eavesdropper channel, the result is security at the physical layer even if the eavesdropper has knowledge of the transform used by the transmitter. The distance between the eavesdropper and the transmitter can also contribute to this bit error rate. For example, in wireless communications, signal power (and thus signal quality) degrades with the square of the distance that a signal travels.

The inventive security techniques disclosed herein operate by pre-processing data at the physical layer of a transmitter. For example, in some transmitter embodiments that involve channel coding followed by modulation, the secure transform is performed before the channel coding. As another example, in some transmitter embodiments that involve modulation without channel coding, the secure transformed is performed before the modulation. This pre-processing can be implemented by specialized hardware, by instructions executing on a processor, or by a combination thereof.

The inventive pre-processor transforms disclosed herein use rate-1 non-recursive (R1NR) convolutional encoders in combination with bit-level permuters. More specifically, M rate-1 non-recursive convolutional encoders are placed in series, with M−1 bit-level permuters interspersed between adjacent encoders, where M>=2. Thus, the output of one R1NR convolutional encoder is the input to a bit-level permuter, and the output of that bit-level permuter is the input of the next R1NR convolutional encoder.

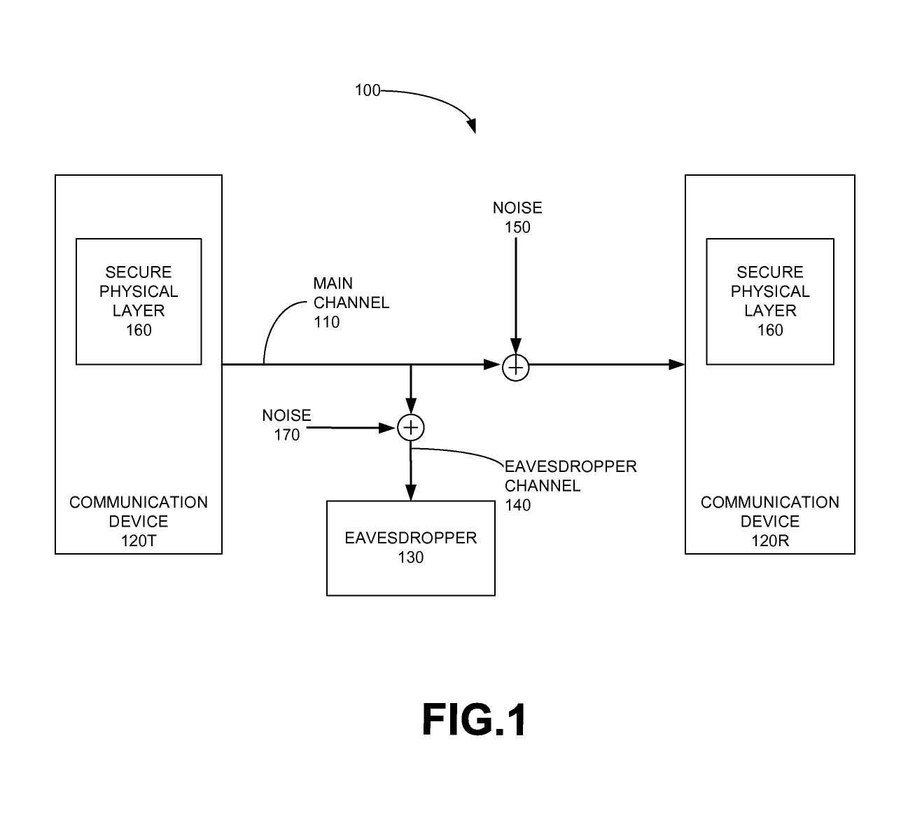

FIG. 1 is a system diagram of a transmitter device and a receiver device utilizing at pre-processing at the physical layer to provide secure communication. Communication system 100 includes two parties that communicate over a main channel 110: communication device 120T, operating as a transmitter; and 120R, operating as a receiver. Although transmit and receive operations are discussed separately herein, a person of ordinary skill in the art would understand that some embodiments of device 120 have both transmitter and receiver functionality.

System 100 accounts for another device 130 (an “eavesdropper”) which may listen to (eavesdrop on) transmissions on main channel 110, over an eavesdropper channel 140. Eavesdropper 130 is passive with respect to main channel 110, i.e., eavesdropper 130 does not jam main channel 110, insert bits on main channel 110, etc. In some embodiments, main channel 110 and eavesdropper channel 140 are wireless. In one of these embodiments, transmitter 120T and receiver 120R are implemented using radio frequency identification (RFID) tags. In other embodiments, main channel 110 and eavesdropper channel 140 are wired (wireline) channels.

Main channel 110 is subject to a noise input 150. As a result, communication from transmitter 120T to receiver 120R over main channel 110 is not error-free. The performance of main channel 110 can be described in terms of a bit error rate (BER) at receiver 120R, which can also be understood as a probability of error (p_{M}) at receiver 120R. Considering a single bit, the probability of receiver 120R seeing a 1 when transmitter 120T actually sent a 0, or seeing a 0 when transmitter 120T actually sent a 1, is p_{MAIN}. Conversely, the probability of receiver 120R seeing a 1 when transmitter 120T actually sent a 1, or seeing a 0 when transmitter 120T actually sent a 0, is 1−p_{MAIN}.

A secure physical layer 160 residing in transmitter 120T conveys information across main channel 110, where it is recovered by a secure physical layer 160 residing in receiver 120R. Though not discussed in detail herein, communication device 120 may implement other layers above secure physical layer 160, for example a Media Access Control (MAC) layer, a network layer, a transport layer, a session layer, etc. Secure physical layer 160 uses techniques such as modulation, line coding, etc. to convey information in a manner which takes into account the physical characteristics of main channel 110. Secure physical layer 160 may also use techniques such as channel coding and/or error correction to convey information in a manner which takes into account noise input 150, thus reducing p_{MAIN} as compared to performance without such techniques. As noted above and described in further detail below, inventive embodiments of secure physical layer 160 as disclosed herein provide physical layer security through various pre-processing techniques. The physical layer security techniques can also be combined with security provided by a higher protocol layer. Thus, some embodiments of transmitter 120T and receiver 120R include encryption at higher layers of the protocol stack in addition to the security provided by secure physical layer 160.

Transmitter 120T communicates to receiver 120R a description of the convolutional encoders and permuters utilized in secure physical layer 160 of transmitter 120T. This knowledge of the particular parameters used by the R1NR convolutional encoders and permuters to produce the secure bit stream allows receiver 120R to construct and/or configure a corresponding set of R1NR convolutional decoders and inverse permuters which operate to recover the original user data carried in the secure bit stream.

As noted earlier, eavesdropper 130 uses eavesdropper channel 140 to intercept communications between transmitter 120T and receiver 120R. Eavesdropper 130 then decodes intercepted data in an attempt to recover user data conveyed from transmitter 120T and receiver 120R. However, eavesdropper channel 140 is subject to a noise input 170 with characteristics different from noise input 150. The probability of error at eavesdropper 130 is referred to herein as p_{EVE}. Secure physical layer 160 between transmitter 120T and receiver 120R provides physical layer security when p_{EVE} is about one-half, since in this scenario it is just as likely that decoding a bit received by eavesdropper 130 produces an incorrect value as it is that the decode produces the correct value. The one-half value for P_{EVE} is a result of the specific characteristics of the R1NR convolutional encoders and permuters utilized in secure physical layer 160 of transmitter 120T. That is, the security transform used by transmitter 120T has characteristics such that if a 1 is transmitted, eavesdropper 130 is as likely to recover a 0 as a 1; similarly, the characteristics lead to eavesdropper 130 being just as likely to (incorrectly) recover a 1 when a 0 is transmitted as to (correctly) recover a 0 when the 0 is transmitted. As used herein, the term “about” can include traditional rounding according to significant figures of numerical values.

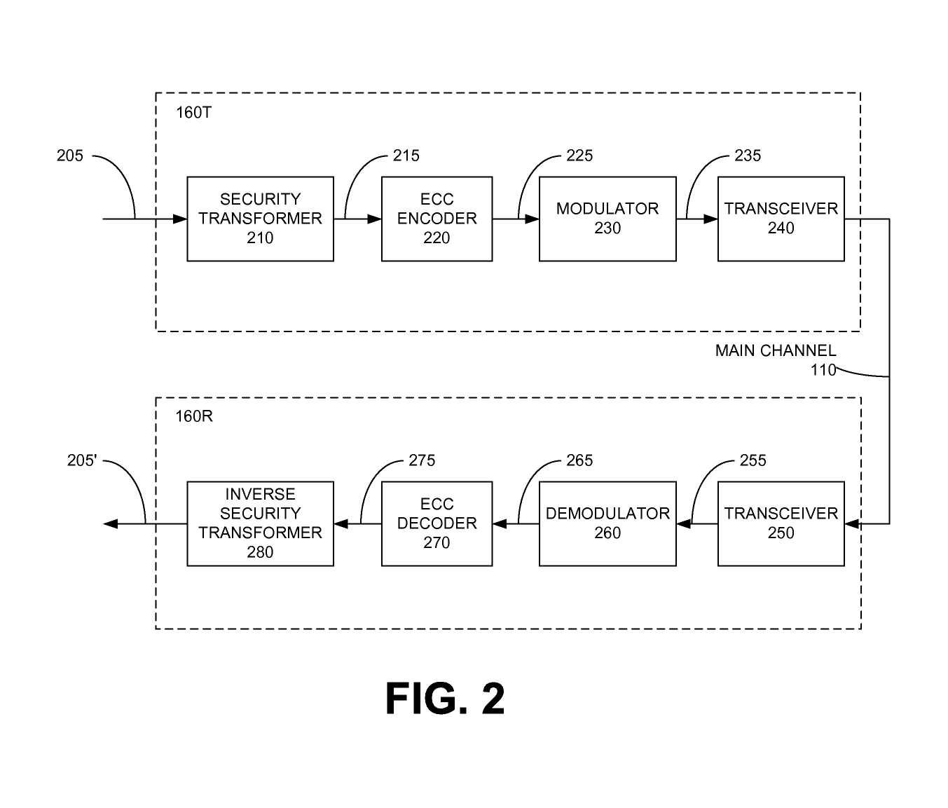

FIG. 2 is a block diagram showing various components of secure physical layer 160 in a system including a transmitter and a receiver. In secure physical layer 160T (residing in transmitter 120T of FIG. 1), an input bit stream 205 containing user data for transmission is pre-processed by security transformer 210. As will described in more detail below, security transformer 210 utilizes a combination of rate-1 non-recursive convolutional coding and bit permutation, where the coding and permutation is designed to achieve p_{EVE}˜0.5. The transformed bit stream 215 that is generated by security transformer 210 is provided to error correction code (ECC) encoder 220, and the error-corrected bit stream 225 is provided to a modulator 230. The modulated bit stream 235 generated by modulator 230 is then transmitted onto main channel 110 by a network transceiver 240.

In secure physical layer 160R (residing in receiver 120R of FIG. 1), a network transceiver 250 receives the noisy bit stream (i.e., modulated stream 235 affected by noise input 150). The received modulated bit stream 255 is processed by a demodulator 260, recovering symbols carried in the bit stream. Error correction on the demodulated bit stream 265 is then handled by an ECC decoder 270. The corrected bit stream 275 is post-processed by inverse security transformer 280 to recover a replica 205′ of the originally transmitted input bit stream 205. Stream 205′ is considered to be merely a replica, and not necessarily a perfect copy, of the bit stream 205 originally present at transmitter 120T because some errors produced by noise input 150 may escape detection and/or correction.

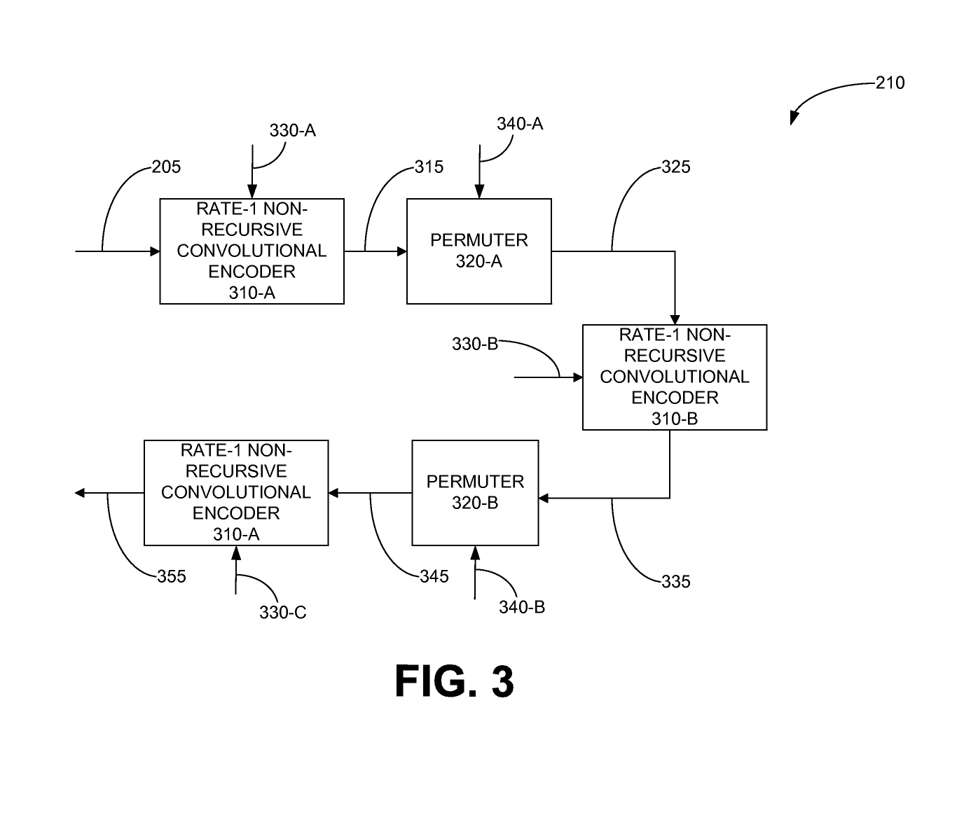

FIG. 3 is a block diagram of security transformer 210 according to some embodiments described herein. Security transformer 210 includes a cascading arrangement of M rate-1 non-recursive convolutional encoders 310 and M−1 bit-level permuters 320. This example embodiment includes three R1NR convolutional encoders 310 and two bit-level permuters 320. The structure, and thus the operation, of each R1NR convolutional encoder 310 is specified by configuration information 330 and the structure of each bit level permuter 320 is specified by configuration information 340. This configuration information includes parameters that describe the structure (and thus operation) of these components. In one embodiment, convolutional encoder configuration information 330 includes a set of initial values, a shift register depth, a number of adders, and the location of a set of taps off encoder 310. In one embodiment, permuter configuration information 340 includes a mapping of input bit locations to output bit locations.

In some embodiments, configuration information 330, 340 is shared privately between a particular transmitter-receiver pair, while in others it is public. In some embodiments, configuration information 330, 340 is specified at run-time, while in others it is hard-coded for a particular implementation. In some embodiments, configuration information 330, 340 takes the form of a bit vector. However, many other ways of implementing configuration information 330, 340 are contemplated, including (but not limited to) text, a markup language such as eXtensible Markup Language (XML), and serialized XML.

Permuters 320 are interspersed among R1NR convolutional encoders 310, such that the output of one R1NR convolutional encoder 310 serves as the input to a permuter 320, and the output of that permuter 320 serves as input to the next R1NR convolutional encoder 310. Since the number of R1NR convolutional encoders 310 (M) is greater than the number of bit-level permuters 320 (M−1), the last R1NR convolutional encoder 310 is not followed by a permuter 320.

The example embodiment of FIG. 3 includes R1NR convolutional encoder 310-A, 310-B, 310-C, and bit-level permuters 320-A, 320-B. The first R1NR convolutional encoder (310-A) receives user data bit stream 205 as input, and produces a first coded output 315 which is provided to the first permuter 320-A. Permuter 320-A produces a first permuted output 325 which is in turn provided to the second R1NR convolutional encoder 310-B. Second R1NR convolutional encoder 310-B produces a second coded output 335 which is in turn provided to the second permuter 320-B. Permuter 320-B produces a second permuted output 345 which is in turn provided to the third R1NR convolutional encoder 310-C. Third R1NR convolutional encoder 310-C produces a third coded output 355. This final coded output 355 is provided to the next stage of the transmitter physical layer, for example, an error correcting coder or a modulator, for final transmission onto main channel 110.

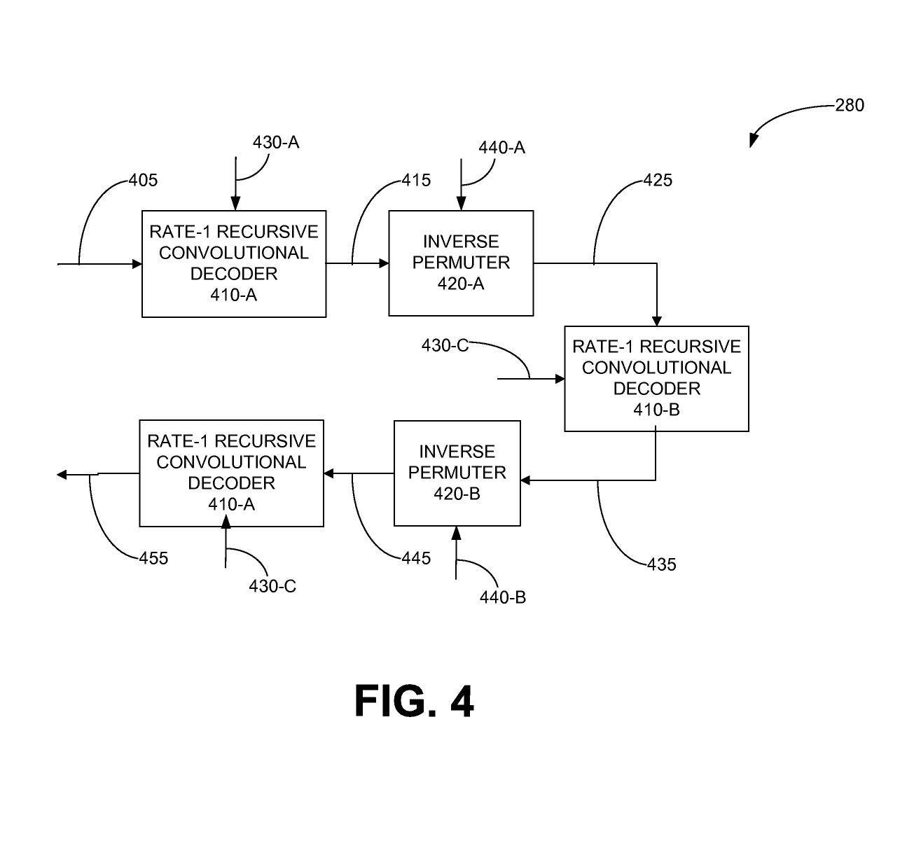

FIG. 4 is a block diagram of inverse security transformer 280 according to some embodiments described herein. Inverse security transformer 280, located in a receiver, is the inverse of security transformer 210 in a transmitter, having a cascading arrangement of M rate-1 recursive (R1R) convolutional decoders 410 and M−1 bit-level inverse permuters 420. The example embodiment of FIG. 4 includes three R1R convolutional decoders 410-A, 410-B, 410-C, and two inverse permuters 420-A, 420-B. The first R1R convolutional decoder 410-A receives a demodulated or a demodulated/corrected bit stream 405 as input from an earlier stage of the receiver physical layer. From this input bit stream 405, first R1R convolutional decoder 410A produces a first decoded output 415 which is provided to the first inverse permuter 420A. First inverse permuter 420A produces a first inverse permuted output 425 which is in turn provided to the second R1R convolutional decoder 410B. Second R1NR convolutional decoder 410B produces a second decoded output 435 which is in turn provided to the second inverse permuter 420B. Second inverse permuter 420-B produces a second permuted output 445 which is in turn provided to the third R1R convolutional decoder 410-C. Third R1R convolutional decoder 410-C produces a third decoded output 455. The result of the post-processing by inverse security transformer 280 (output 455) corresponds to bit stream 205′, which is a replica of the original input bit stream 205 at transmitter 120T.

Like security transformer 210, the components of inverse security transformer 280 have a structure/behavior specified by configuration information. Notably, a particular embodiment of inverse security transformer 280 is interoperable with a particular embodiment of security transformer 210. In other words, if security transformer 210 includes two encoders and a permuter described by configuration parameters CE1, P1, CE2, then inverse security transformer 280 includes two decoders and an inverse permuter described by configuration parameters C̅E̅₁̅, P̅₁̅, C̅E̅₂̅ (where the bar over the parameter denotes inverse).

The use of R1NR convolutional coding and permutation in the security transformer embodiments described herein differs, in various aspects, from the conventional use of these components. In conventional communication systems, where convolutional coding is used for error detection and correction, it is desirable for many devices to use the same convolutional code or series of codes. Knowledge of a common coding scheme allows a particular transmitter to communicate with as many receivers as possible, and this interoperability is generally desirable. In contrast, in the systems disclosed herein, the goal is data security rather than error detection/correction, so different transmitter-receiver pairs may use different R1NR coding schemes and different arrangements of R1NR coders and permuters.

In conventional communication systems, the operation and structure of a convolutional coder or permuter is fixed, while the data varies. That is, all transmitter-receiver pairs use the same coding/permuting scheme. Despite the fact that the scheme is known by many parties, security is nonetheless provided, by virtual of a data value called a key. That is, executing a known coding/permutation algorithm with device pair A-B produces a different result than does the same algorithm used by device pair C-D, because pair A-B uses a different key than pair C-D. In contrast, the inventive techniques described herein use one transform scheme (specified as a set of R1NR coding and permutation parameters) for pair A-B and a different scheme (specified by different parameters) for pair C-D. This approach allows all devices to use the same underlying hardware or firmware, while the operation of that hardware or firmware depends on the configuration data that specifies the transform scheme.

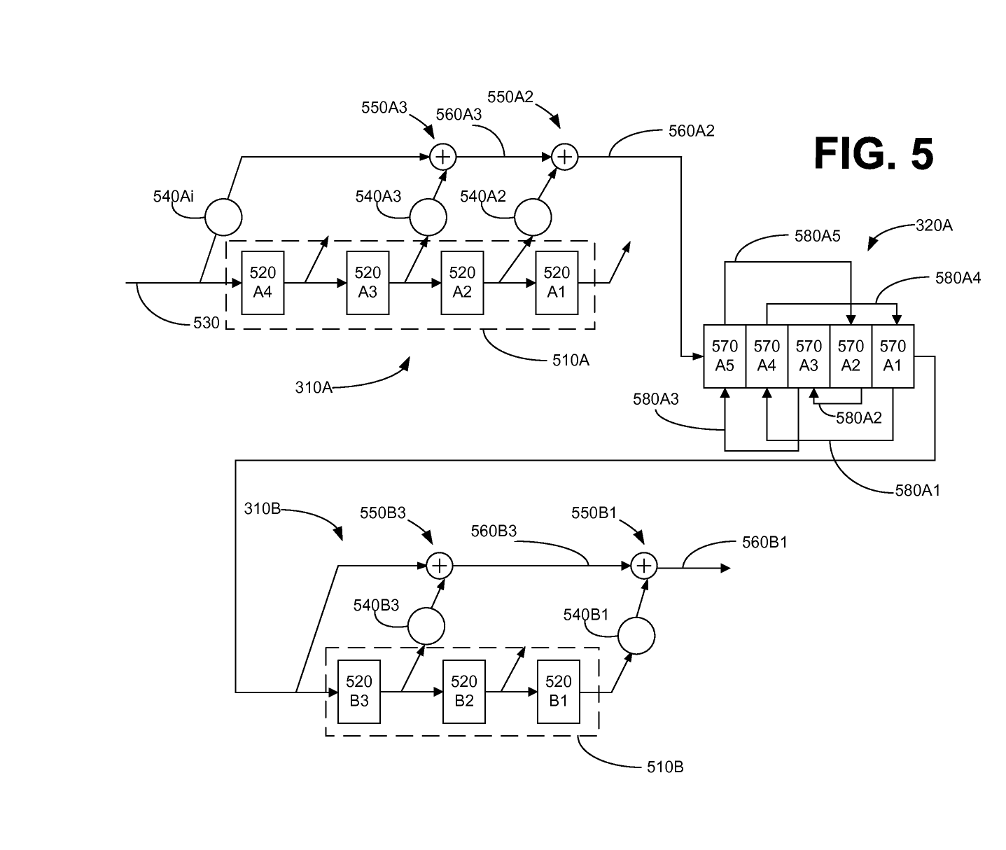

FIG. 5 is another block diagram of security transformer 210, showing additional details of the structure and operation of this component. As described earlier, security transformer 210 is constructed as a cascading series of R1NR convolutional encoders 310 and bit-level permuters 320. In the example of FIG. 5, security transformer 210 includes two R1NR convolutional encoders 310A, B and a single bit level permuter 320A.

Each R1NR convolutional encoder 310 includes a shift register 510 where each shift register 510 includes a plurality of bit positions 520, corresponding to delay elements. That is, each bit remains in its current position for one delay period before being shifted to the next position. In this example, R1NR convolutional encoder 310A has 4 bit positions 520A1-4, and R1NR convolutional encoder 310B has 3 bit positions 520B1-3. The number of bit positions in a shift register is referred to herein as the shift register depth. These bit positions 520 are initialized according to values specified by encoder configuration information 330. After initialization, a shift register 510 then receives successive values from a serial bit stream 530, one cycle at a time. As known to a person of ordinary skill in the art, shift register 510 operates by shifting all bits one position on every shift cycle. The shift is always in the same direction. In the example illustration, bits enter security transformer 210 at the left side of the diagram and exit at the right side, so shifts move bits to the right. However, this is merely a notational convenience.

Each R1NR convolutional encoder 310 also includes a set of taps 540, which provide the value of a particular bit position 520 as an input to another component. Here, R1NR convolutional encoder 310A includes taps 540A2, A3, which provide the value at positions 520A2, A3 respectively, as well as 540Ai, which provides the current value of the input bit stream 530 (before entering the register). Similarly, R1NR convolutional encoder 310B includes taps 540B1, B3 which provide the value at positions 520B1, B3 respectively. Some bit positions 520 may not be tapped, and thus do not contribute to the generated code bit.

Also included in each R1NR convolutional encoder 310A, B is a set of bit-level adders 550, each of which accepts a particular set of taps 540 as input. In this example, R1NR convolutional encoder 310A includes adders 550A2 and 550A3, which produce outputs 560A2 and 560A3 respectively, and R1NR convolutional encoder 310B includes adders 550B3 and 550B1, which produce outputs 560B3 and 560B1 respectively. Notably, the number of adders 550 for a given shift register 510 can be less than the number of bit positions for that shift register 510; or, put another way, some bit positions may not be input to an adder 550. The arrangement of taps 540 and adders 550 in a particular R1NR convolutional encoder 310 is controlled by encoder configuration information 330. Because R1NR convolutional encoder 310 is non-recursive, there is no feedback from the output path back to the input path.

As noted earlier, with every shift cycle, the values in a shift register 510 move from one bit position 520 to the adjacent position. The taps 540 then feed values at their corresponding bit positions 520 as input to adders 550. Adders 550 in turn sum their bit value inputs to produce corresponding sums 560. The final sum (here, sum 560A2) feeds into the next component of security transformer 210, which is a bit level permuter 320. After shifting through all four bit positions 520, the shift cycle for an R1NR convolutional encoder 310 continues with a new bit from input bit stream 530.

A bit level permuter 320 is implemented as a register with multiple bit positions 570 and a set of taps 580 providing access to those positions 570. Instead of simply shifting from one adjacent position to another, a bit level permuter 320 maps a set of input bit positions to a set of output bit positions. Put another way, bit level permuter 320 “shuffles” bits according to a mapping specified by permuter configuration data 340. In some embodiments, the mapping can be completely arbitrary, i.e., a particular bit can move into any other bit position. In other embodiments, the mapping may be more limited, i.e., the register is divided into two halves and a particular bit can only move within the same register half. The example of FIG. 5 illustrates such an arbitrary mapping: tap 580A1 moves position 570A1 into 570A4; tap 580A2 moves position 570A2 into 570A3; tap 580A3 moves position 570A3 into 570A5; tap 580A4 moves position 570A4 into 570A2; and tap 580A5 moves position 570A5 into 570A2.

As explained above, a security transformer 210 in a transmitter 120T communicates with a particular inverse security transformer 280 in a receiver 120R. Though not illustrated, the structure of inverse security transformer 280 is complementary to its peer security transformer 210. That is, an inverse security transformer 280 in communication with the security transformer 210 of FIG. 5 would include a bit permuter that moves bit position 5 back to its original bit position 2, moves bit position 4 back to its original bit position 1, moves bit position 3 back to its original bit position 2, moves bit position 2 back to its original bit position 5, and bit position 1 back to its original bit position 4. The peer inverse security transformer 280 for the transformer of FIG. 5 also includes two rate-1 convolutional decoders 410 arranged in the same manner as the encoders 310 of FIG. 5, but the decoders 410 are recursive rather than non-recursive, and as such include feedback from the output path back to the input path.

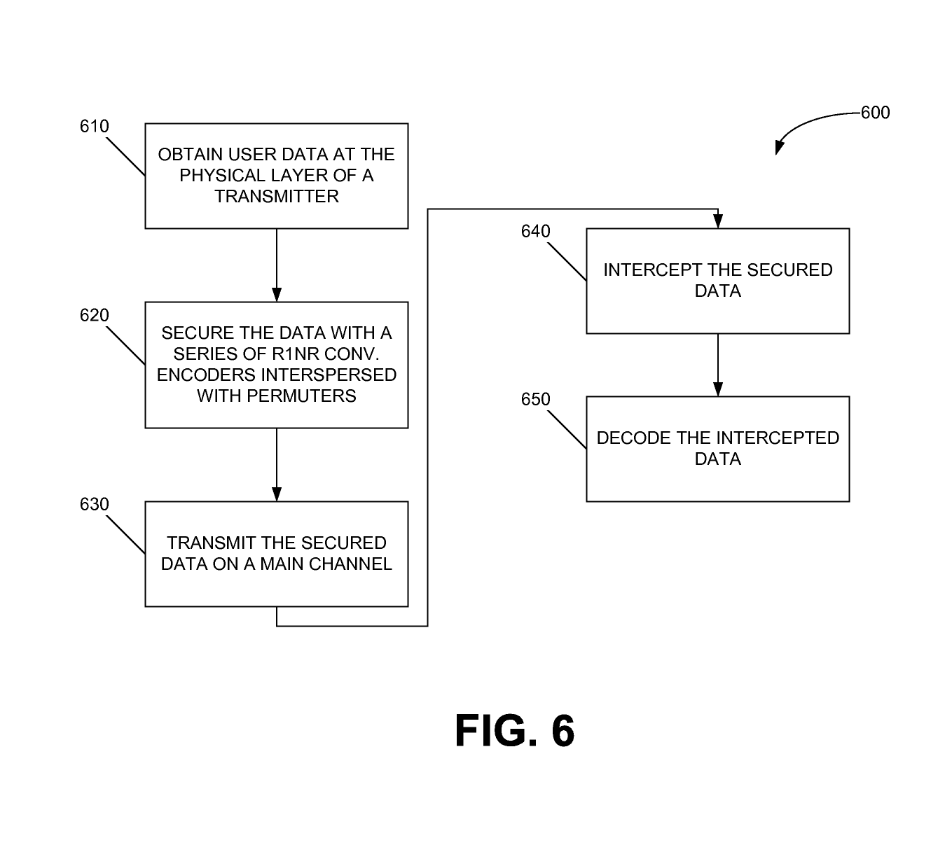

FIG. 6 is a flow chart illustrating operation of communication system 100 according to some embodiments disclosed herein. Process 600 begins at block 610, where secure physical layer 160T (in transmitter 120T) obtains user data. The data may be obtained, for example, from a Media Access Control (MAC) layer, a link layer, or a higher protocol layer of transmitter 120T. Next, at block 620, secure physical layer 160T secures (i.e., provides security for) the user data using the techniques described herein, by processing the data with a series of R1NR convolutional encoders 310 (FIG. 3) that are interspersed with one or more bit-level permuters 320 (FIG. 3). In some embodiments, R1NR convolutional encoders 310 process all the bits in the user data, leaving no bits uncoded.

At block 630, secure physical layer 160T transmits the secure user data on main channel 110 (FIG. 1) to receiver 120R. In some embodiments, the transmitted data includes an address that indicates the data is destined for, or intended for, the particular receiver 120R. Next, at block 640, eavesdropper 130 (FIG. 1) listens on eavesdropper channel 140 (FIG. 1) and intercepts the transmitted data. This intercepted data includes a contribution by noise input 170 (FIG. 1), which results in a particular number of errors in the intercepted data. At block 650, eavesdropper 130 decodes the intercepted data, but because the characteristics of R1NR convolutional encoders 310 and bit-level permuters 320 are chosen to produce a low quality signal with a p_{EVE} value of about one-half, eavesdropper 130 is unable to successfully recover the user data transmitted from transmitter 120T to receiver 120R. As noted above, the security pre-processing used by transmitter 120T has characteristics such that if a 1 is transmitted, eavesdropper 130 is as likely to recover a 0 as a 1; similarly, the characteristics lead to eavesdropper 130 being just as likely to (incorrectly) recover a 1 when a 0 is transmitted as to (correctly) recover a 0 when the 0 is transmitted.

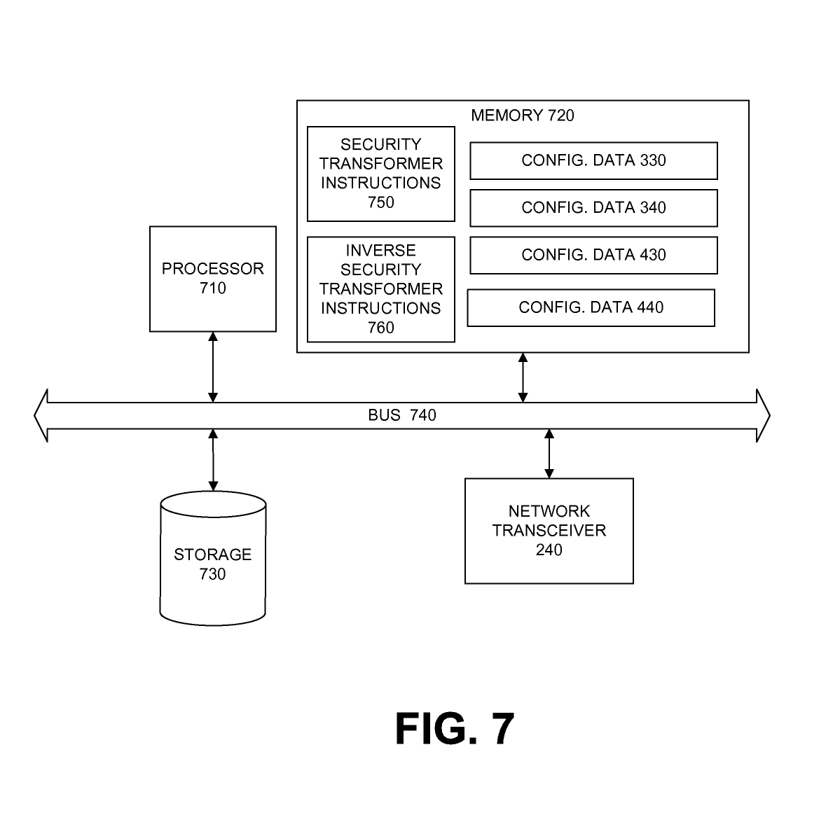

FIG. 7 is a hardware block diagram of an embodiment of communication device 120 in which security transformer 210 and inverse security transformer 280 are implemented in software or firmware, that is, as instructions stored in a memory and executed by a suitable microprocessor, digital signal processor, network processor, microcontroller, etc. Communication device 120 contains a number of components that are well known in the art of data communications, including a processor 710, a network transceiver 240, memory 720, and non-volatile storage 730. These components are coupled via a bus 740. Network transceiver 240 may support one or more of a variety of different networks using various technologies, media, speeds, etc. A non-limiting list of examples of wireless technologies includes: radio frequency identification (RFID) networks (e.g., ISO 14443, ISO 18000-6); wireless near field communications (NFC), wireless local area networks (e.g. IEEE 802.11, commonly known as WiFi); wireless wide area networks (e.g., IEEE 802.16, commonly known as WiMAX); wireless personal area networks (e.g., Bluetooth™, IEEE 802.15.4) and wireless telephone networks (e.g., CDMA, GSM, GPRS, EDGE).

Examples of non-volatile storage include, for example, a hard disk, flash RAM, flash ROM, EPROM, etc. memory 720 contains security transformer instructions 750 and/or inverse security transformer instructions 760, which programs or enables processor 710 to implement the functions of security transformer 210 and/or inverse security transformer 280. Omitted from FIG. 7 are a number of conventional components, known to those skilled in the art, that are not necessary to explain the operation of communication device 120. The embodiment of FIG. 7 may also contain software to implement functions such as management, initialization of hardware, protocol stack layers, etc.

Some embodiments of security transformer 210 and/or inverse security transformer 280 are stored on a computer-readable medium, which in the context of this disclosure refers to any structure which can contain, store, or embody instructions executable by a processor. The computer readable medium can be, for example but not limited to, based on electronic, magnetic, optical, electromagnetic, infrared, or semiconductor technology. Specific examples of a computer-readable medium using electronic technology would include (but are not limited to) the following: a random access memory (RAM); a read-only memory (ROM); and an erasable programmable read-only memory (EPROM or Flash memory). A specific example using magnetic technology includes (but is not limited to) a disk drive; and a portable computer diskette. Specific examples using optical technology include (but are not limited to) a compact disk read-only memory (CD-ROM) or a digital video disk read-only memory (DVD-ROM).

Other embodiments of security transformer 210 and/or inverse security transformer 280 (not illustrated) are implemented in hardware logic, as security transformer logic and inverse security transformer logic. Technologies used to implement security transformer logic and inverse security transformer logic in specialized hardware may include, but are not limited to, a programmable logic device (PLD), a programmable gate array (PGA), field programmable gate array (FPGA), an application-specific integrated circuit (ASIC), a system on chip (SoC), and a system on packet (SoP). In yet another embodiment of communication device 120 (not illustrated), security transformer 210 and/or inverse security transformer 280 are implemented by a combination of software (i.e., instructions executed on a processor) and hardware logic.

Any process descriptions or blocks in flowcharts would be understood as representing modules, segments, or portions of code which include one or more executable instructions for implementing specific functions or steps in the process. As would be understood by those of ordinary skill in the art of the software development, alternate implementations are also included within the scope of the disclosure. In these alternate implementations, functions may be executed out of order from that shown or discussed, including substantially concurrently or in reverse order, depending on the functionality involved.

The foregoing description has been presented for purposes of illustration and description. It is not intended to be exhaustive or to limit the disclosure to the precise forms disclosed. Obvious modifications or variations are possible in light of the above teachings. The implementations discussed, however, were chosen and described to illustrate the principles of the disclosure and its practical application to thereby enable one of ordinary skill in the art to utilize the disclosure in various implementations and with various modifications as are suited to the particular use contemplated. All such modifications and variation are within the scope of the disclosure as determined by the appended claims when interpreted in accordance with the breadth to which they are fairly and legally entitled.

What is claimed is:

1. A method of securing user data during transmission, the method comprising:
obtaining user data at a physical layer of a transmitter;
securing the user data, at the physical layer, by processing the user data with a series of rate-1 non-recursive convolutional encoders interspersed with one or more bit-level permuters; and
transmitting the secured user data.

2. The method of claim 1, wherein the processing is performed on all bits of the user data.

3. The method of claim 1, further comprising:
configuring operation of each of the rate-1 non-recursive convolutional encoders with respective encoder configuration information; and
configuring operation of each of the bit-level permuters with permuter configuration information.

4. The method of claim 3, wherein the encoder configuration information is specified as a bit vector.

5. The method of claim 1, wherein the transmitting comprises:
modulating the secured user data with a carrier; and
transmitting the modulated user data.

6. The method of claim 1, wherein the transmitting comprises:
encoding the secured user data with an error correction code (ECC);
modulating the encoded user data with a carrier; and
transmitting the modulated user data.

7. A physical layer security device comprising:
a series of rate-1 non-recursive convolutional encoders; and
one or more bit-level permuters, each of the bit-level permuters positioned between adjacent ones of the non-recursive convolutional encoders,
wherein operation of each of the rate-1 non-recursive convolutional encoders is specified by respective encoder configuration information received by the respective non-recursive convolutional encoder;
wherein operation of each of the bit-level permuters is specified by permuter configuration information received by the respective bit-level permuter.

8. The physical layer security device of claim 7, wherein the encoder configuration information is specified as a bit vector.

9. The physical layer security device of claim 7, wherein the permuter configuration information is specified as a bit vector.

10. The physical layer security device of claim 7, wherein the operation of each of the rate-1 non-recursive convolutional encoders is further specified by respective initial state information.

11. The physical layer security device of claim 7, wherein each of the rate-1 non-recursive convolutional encoders is operable to generate a respective coded data stream having a specific bit order, wherein each of the bit-level permuters is operable to receive one of the coded data streams in the specific bit order.

12. The physical layer security device of claim 7, wherein the plurality of rate-1 non-recursive convolutional encoders is operable to encode all bits of user data.

13. A physical layer security device comprising:
a series of non-recursive shift registers, each of the non-recursive shift registers having a plurality of bit positions;
a plurality of adders associated with each of the non-recursive shift registers, each adder having a single output and a plurality of inputs;
a plurality of taps coupled to each of the non-recursive shift registers, each tap connecting a selected one of the bit positions to one of the inputs of a selected adder; and
one or more bit-level permuters, each of the bit-level permuters positioned between adjacent ones of the non-recursive shift registers and having, as input, a selected one of the adder outputs.

14. The physical layer security device of claim 13, wherein the tap connections for each non-recursive shift register are specified by respective shift register configuration information and wherein the input to each of the bit-level permuters is specified by respective permuter configuration information.

15. The physical layer security device of claim 14, wherein the respective shift register configuration information is specified as a bit vector.

16. The physical layer security device of claim 13, wherein each of the non-recursive shift registers is operable to receive initial values for respective bit positions.

17. A physical layer security device comprising:
a combination of a series of rate-1 non-recursive convolutional encoders interspersed with one or more bit-level permuters, the combination operable to securely transform a bit stream;
a modulator operable to modulate the transformed bit stream with a carrier; and
a transceiver operable to transmit the modulated bit stream.

18. The physical layer security device of claim 17, wherein operation of each of the rate-1 non-recursive convolutional encoders is specified by respective encoder configuration information and initial state information received by the respective non-recursive convolutional encoder.

19. The physical layer security device of claim 18, wherein the respective encoder configuration information is specified as a bit vector.

20. The physical layer security of claim 17, wherein operation of each of the bit-level permuters is specified by permuter configuration information received by the respective bit-level permuter.
